(19) United States
(12) Patent Application Publication
(10) Pub. No.: US 2025/0135636 A1
(43) Pub. Date: May 1, 2025

(54) SYSTEMS AND METHODS FOR GRASPING OBJECTS WITH UNKNOWN OR UNCERTAIN EXTENTS USING A ROBOTIC MANIPULATOR

(71) Applicant: Boston Dynamics, Inc., Waltham, MA (US)

(72) Inventors: Samuel Shaw, Somerville, MA (US); Scott Gilroy, Waltham, MA (US); Maurice Rahme, Cambridge, MA (US); Neil M. Neville, Waltham, MA (US)

(73) Assignee: Boston Dynamics, Inc., Waltham, MA (US)

(21) Appl. No.: 18/926,580

(22) Filed: Oct. 25, 2024

Related U.S. Application Data
(60) Provisional application No. 63/593,623, filed on Oct. 27, 2023.

(51) Int. Cl. B25J 9/16; B25J 13/08; B25J 15/06

(52) U.S. Cl. CPC B25J 9/1612; B25J 9/1697; B25J 13/082; B25J 15/0616

(57) ABSTRACT

Methods and apparatus for grasping an object by a suction-based gripper of a mobile robot are provided. The method comprises receiving, by a computing device, from a perception system of the mobile robot, perception information reflecting an object to be grasped by the suction-based gripper, determining, by the computing device, uncertainty information reflecting an unknown or uncertain extent and/or pose of the object, determining, by the computing device, a grasp strategy to grasp the object based, at least in part, on the uncertainty information, and controlling, by the computing device, the mobile robot to grasp the object using the grasp strategy.

### RELATED APPLICATIONS

This application claims the benefit under 35 U.S.C. § 119 (e) to U.S. Provisional Patent Application No. 63/593,623, filed Oct. 27, 2023 titled, “SYSTEMS AND METHODS FOR GRASPING OBJECTS WITH UNKNOWN OR UNCERTAIN EXTENTS USING A ROBOTIC MANIPULATOR,” the entire contents of which is incorporated by reference herein.

### FIELD OF THE INVENTION

This disclosure relates to techniques for grasping objects using a robotic manipulator.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

Robots may be configured to grasp objects (e.g., boxes) and move them from one location to another using, for example, a robotic arm with a suction-based gripper attached thereto. For instance, the robotic arm may be positioned such that one or more suction cups of the gripper are in contact with (or are near) a face of an object to be grasped. An on-board vacuum system may then be activated to use suction to adhere the object to the gripper. In some scenarios, the pose and/or one or more extents of the object to be grasped may be uncertain or unknown. For example, a perception system of the robot may sense the width and height of the object, but the depth may not be known. Alternatively, the perception system of the robot may sense the width and depth of the object, but the height may not be known. In such scenarios it may be challenging to approach and achieve a secure grasp on the object without damaging the object (e.g., by impacting the object with too much force) and/or other objects near the object. To this end, some embodiments of the present disclosure relate to grasping techniques for a robotic manipulator that take into account uncertainty in extents and/or pose of objects to be grasped by the robotic manipulator.

In one aspect, the invention features a method of grasping an object by a suction-based gripper of a mobile robot. The method includes receiving, by a computing device, from a perception system of the mobile robot, perception information reflecting an object to be grasped by the suction-based gripper, determining, by the computing device, uncertainty information reflecting an unknown or uncertain extent and/or pose of the object, determining, by the computing device, a grasp strategy to grasp the object based, at least in part, on the uncertainty information, and controlling, by the computing device, the mobile robot to grasp the object using the grasp strategy.

In some embodiments, receiving perception information reflecting an object to be grasped comprises receiving information on a first extent and a second extent of a first face of the object, and determining uncertainty information comprises determining uncertainty information for a third extent of a second face of the object. In some embodiments, the second face shares one of the first extent or the second extent with the first face. In some embodiments, the first face is a side face of the object and the second face is a top face of the object. In some embodiments, the first extent is a width of the first face, the second extent is a height of the first face, and the third extent is a depth of the second face. In some embodiments, the first extent is a width of the first face, the second extent is a depth of the first face, and the third extent is a height of the second face.

In some embodiments, determining a grasp strategy includes assigning a classification to each of a plurality of suction cups of the suction-based gripper based, at least in part, on the uncertainty information and an orientation of the suction-based gripper relative to a face of the object having an uncertain extent, and controlling the mobile robot to grasp the object includes controlling the mobile robot to grasp the object based, at least in part, on the classification assigned to each of the plurality of suction cups of the suction-based gripper. In some embodiments, determining uncertainty information for a third extent of a second face of the object includes defining a first polygon relative to the second face, wherein the first polygon has a first value for the third extent, and defining a second polygon relative to the second face, wherein the second polygon has a second value for the third extent, wherein the second value is larger than the first value. In some embodiments, assigning a classification to each of a plurality of suction cups of the suction-based gripper includes associating a first classification with a suction cup located within the first polygon, and associating a second classification with a suction cup located outside of the first polygon and within the second polygon. In some embodiments, controlling the mobile robot to grasp the object comprises selectively activating suction cups associated with the first classification.

In some embodiments, controlling the mobile robot to grasp the object includes activating suction cups associated with the first classification at a first time, and activating a first subset of suction cups associated with the second classification at a second time after the first time. In some embodiments, controlling the mobile robot to grasp the object further includes activating a second subset of suction cups associated with the second classification at a third time after the second time, and the second subset includes at least one suction cup from the first subset and at least one suction cup not included in the first subset. In some embodiments, the at least one suction cup not included in the first subset comprises a suction cup neighboring a suction cup in the first subset having a seal quality above a threshold seal quality. In some embodiments, controlling the mobile robot to grasp the object further includes deactivating one or more of the suction cups in the first subset having a seal quality below a threshold seal quality. In some embodiments, the method further includes selecting suction cups to include in the first subset based, at least in part, on an amount of available vacuum pressure for the mobile robot. In some embodiments, the method further includes selecting suction cups to include in the first subset based, at least in part, on an amount of flow allowed through the suction-based gripper. In some embodiments, the method further includes selecting suction cups to include in the first subset based, at least in part, on the orientation of the suction-based gripper relative to the face of the object.

In some embodiments, determining a grasp strategy includes determining a pick trajectory of a manipulator including the suction-based gripper based, at least in part, on the uncertainty information, and controlling the mobile robot to grasp the object comprises controlling the mobile robot to grasp the object based, at least in part, on the determined pick trajectory. In some embodiments, determining a pick trajectory of the manipulator includes determining a terminal end-effector pose of the pick trajectory based, at least in part, on the uncertainty information. In some embodiments, determining a pick trajectory of the manipulator further includes determining an intermediate end-effector pose of the pick trajectory, and determining the pick trajectory by constraining the pick trajectory to follow a target twist with a constant angular component from the intermediate end-effector pose to the terminal end-effector pose. In some embodiments, the intermediate end-effector pose is determined, at least in part, on the terminal end-effector pose. In some embodiments, the intermediate end-effector pose is determined, at least in part, on a reach of the manipulator. In some embodiments, the intermediate end-effector pose is determined, at least in part, on a height of a distance sensor on a base of the mobile robot. In some embodiments, controlling the mobile robot to grasp the object based, at least in part, on the determined pick trajectory includes detecting, as the manipulator is advanced along the pick trajectory, that a force associated with the manipulator exceeds a threshold value, and stopping advancing of the manipulator in response to determining that the force exceeds the threshold value. In some embodiments, controlling the mobile robot to grasp the object based, at least in part, on the determined pick trajectory further includes sensing, using a wrench sensor arranged on the manipulator, the force as a contact force between the manipulator and the object. In some embodiments, controlling the mobile robot to grasp the object based, at least in part, on the determined pick trajectory further includes activating one or more suction cups of the suction-based gripper as the manipulator is advanced along the pick trajectory, and sensing as the force, a seal quality between one or more of the activated one or more suction cups and the object.

In one aspect, the invention features a mobile robot. The mobile robot includes a suction-based gripper, a perception system, and at least one computing device. The at least one computing device is programmed to receive from the perception system, perception information reflecting an object to be grasped by the suction-based gripper, determine uncertainty information reflecting an unknown or uncertain extent and/or pose of the object, determine a grasp strategy to grasp the object based, at least in part, on the uncertainty information, and control the mobile robot to grasp the object using the grasp strategy.

In some embodiments, receiving perception information reflecting an object to be grasped comprises receiving information on a first extent and a second extent of a first face of the object, and determining uncertainty information comprises determining uncertainty information for a third extent of a second face of the object. In some embodiments, the second face shares one of the first extent or the second extent with the first face. In some embodiments, the first face is a side face of the object and the second face is a top face of the object. In some embodiments, the first extent is a width of the first face, the second extent is a height of the first face, and the third extent is a depth of the second face. In some embodiments, the first extent is a width of the first face, the second extent is a depth of the first face, and the third extent is a height of the second face. In some embodiments, determining a grasp strategy includes assigning a classification to each of a plurality of suction cups of the suction-based gripper based, at least in part, on the uncertainty information and an orientation of the suction-based gripper relative to a face of the object having an uncertain extent, and controlling the suction-based gripper to grasp the object comprises controlling the mobile robot to grasp the object based, at least in part, on the classification assigned to each of the plurality of suction cups of the suction-based gripper.

In some embodiments, determining uncertainty information for a third extent of a second face of the object includes defining a first polygon relative to the second face, wherein the first polygon has a first value for the third extent, and defining a second polygon relative to the second face, wherein the second polygon has a second value for the third extent, wherein the second value is larger than the first value. In some embodiments, assigning a classification to each of a plurality of suction cups of the suction-based gripper includes associating a first classification with a suction cup located within the first polygon, and associating a second classification with a suction cup located outside of the first polygon and within the second polygon. In some embodiments, controlling the mobile robot to grasp the object comprises selectively activating suction cups associated with the first classification. In some embodiments, controlling the mobile robot to grasp the object includes activating suction cups associated with the first classification at a first time, and activating a first subset of suction cups associated with the second classification at a second time after the first time. In some embodiments, controlling the mobile robot to grasp the object further includes activating a second subset of suction cups associated with the second classification at a third time after the second time, and the second subset includes at least one suction cup from the first subset and at least one suction cup not included in the first subset. In some embodiments, the at least one suction cup not included in the first subset comprises a suction cup neighboring a suction cup in the first subset having a seal quality above a threshold seal quality.

In some embodiments, controlling the mobile robot to grasp the object further includes deactivating one or more of the suction cups in the first subset having a seal quality below a threshold seal quality. In some embodiments, the at least one computing device is further programmed to select suction cups to include in the first subset based, at least in part, on an amount of available vacuum pressure for the robot. In some embodiments, the at least one computing device is further programmed to select suction cups to include in the first subset based, at least in part, on an amount of flow allowed through the suction-based gripper. In some embodiments, the at least one computing device is further programmed to select suction cups to include in the first subset based, at least in part, on the orientation of the suction-based gripper relative to the face of the object.

In some embodiments, determining a grasp strategy includes determining a pick trajectory of a manipulator including the suction-based gripper based, at least in part, on the uncertainty information, and controlling the mobile robot to grasp the object comprises controlling the mobile robot to grasp the object based, at least in part, on the determined pick trajectory. In some embodiments, determining a pick trajectory of the manipulator includes determining a terminal end-effector pose of the pick trajectory based, at least in part, on the uncertainty information. In some embodiments, determining a pick trajectory of the manipulator further includes determining an intermediate end-effector pose of the pick trajectory, and determining the pick trajectory by constraining the pick trajectory to follow a target twist with a constant angular component from the intermediate end-effector pose to the terminal end-effector pose. In some embodiments, the intermediate end-effector pose is determined, at least in part, on the terminal end-effector pose. In some embodiments, the intermediate end-effector pose is determined, at least in part, on a reach of the manipulator. In some embodiments, the intermediate end-effector pose is determined, at least in part, on a height of a distance sensor on a base of the mobile robot.

In some embodiments, controlling the mobile robot to grasp the object based, at least in part, on the determined pick trajectory includes detecting as the manipulator is advance along the pick trajectory that a force associated with the manipulator exceeds a threshold value, and stopping advancing of the manipulator in response to determining that the force exceeds the threshold value. In some embodiments, controlling the mobile robot to grasp the object based, at least in part, on the determined pick trajectory further includes sensing, using a wrench sensor arranged on the manipulator, the force as a contact force between the manipulator and the object. In some embodiments, controlling the mobile robot to grasp the object based, at least in part, on the determined pick trajectory further includes activating one or more suction cups of the suction-based gripper as the manipulator is advance along the pick trajectory, and sensing as the force, a seal quality between one or more of the activated one or more suction cups and the object.

In one aspect, the invention features a controller for a mobile robot. The controller includes at least one computing device programed with a plurality of instructions that, when executed, perform a method. The method includes receiving from a perception system of the mobile robot, perception information reflecting an object to be grasped by the mobile robot, determining uncertainty information reflecting an unknown or uncertain extent and/or pose of the object, determining a grasp strategy to grasp the object based, at least in part, on the uncertainty information, and controlling the mobile robot to grasp the object using the grasp strategy.

In some embodiments, receiving perception information reflecting an object to be grasped comprises receiving information on a first extent and a second extent of a first face of the object, and determining uncertainty information comprises determining uncertainty information for a third extent of a second face of the object. In some embodiments, the second face shares one of the first extent or the second extent with the first face. In some embodiments, the first face is a side face of the object and the second face is a top face of the object. In some embodiments, the first extent is a width of the first face, the second extent is a height of the first face, and the third extent is a depth of the second face. In some embodiments, the first extent is a width of the first face, the second extent is a depth of the first face, and the third extent is a height of the second face.

In some embodiments, determining a grasp strategy includes assigning a classification to each of a plurality of suction cups of a suction-based gripper of the mobile robot based, at least in part, on the uncertainty information and an orientation of the suction-based gripper relative to a face of the object having an uncertain extent, and controlling the mobile robot to grasp the object comprises controlling the mobile robot to grasp the object based, at least in part, on the classification assigned to each of the plurality of suction cups of the suction-based gripper. In some embodiments, determining uncertainty information for a third extent of a second face of the object includes defining a first polygon relative to the second face, wherein the first polygon has a first value for the third extent, and defining a second polygon relative to the second face, wherein the second polygon has a second value for the third extent, wherein the second value is larger than the first value. In some embodiments, assigning a classification to each of a plurality of suction cups of the suction-based gripper includes associating a first classification with a suction cup located within the first polygon, and associating a second classification with a suction cup located outside of the first polygon and within the second polygon.

In some embodiments, controlling the mobile robot to grasp the object comprises selectively activating suction cups associated with the first classification. In some embodiments, controlling the mobile robot to grasp the object includes activating suction cups associated with the first classification at a first time, and activating a first subset of suction cups associated with the second classification at a second time after the first time. In some embodiments, controlling the mobile robot to grasp the object further includes activating a second subset of suction cups associated with the second classification at a third time after the second time, and the second subset includes at least one suction cup from the first subset and at least one suction cup not included in the first subset. In some embodiments, the at least one suction cup not included in the first subset comprises a suction cup neighboring a suction cup in the first subset having a seal quality above a threshold seal quality. In some embodiments, controlling the mobile robot to grasp the object further includes deactivating one or more of the suction cups in the first subset having a seal quality below a threshold seal quality.

In some embodiments, the method further includes selecting suction cups to include in the first subset based, at least in part, on an amount of available vacuum pressure for the mobile robot. In some embodiments, the method further includes selecting suction cups to include in the first subset based, at least in part, on an amount of flow allowed through the suction-based gripper. In some embodiments, the method further includes selecting suction cups to include in the first subset based, at least in part, on the orientation of the suction-based gripper relative to the face of the object.

In some embodiments, determining a grasp strategy includes determining a pick trajectory of a manipulator of the mobile robot based, at least in part, on the uncertainty information, and controlling the mobile robot to grasp the object comprises controlling the mobile robot to grasp the object based, at least in part, on the determined pick trajectory. In some embodiments, determining a pick trajectory of the manipulator includes determining a terminal end-effector pose of the pick trajectory based, at least in part, on the uncertainty information. In some embodiments, determining a pick trajectory of the manipulator further includes determining an intermediate end-effector pose of the pick trajectory, and determining the pick trajectory by constraining the pick trajectory to follow a target twist with a constant angular component from the intermediate end-effector pose to the terminal end-effector pose. In some embodiments, the intermediate end-effector pose is determined, at least in part, on the terminal end-effector pose. In some embodiments, the intermediate end-effector pose is determined, at least in part, on a reach of the manipulator. In some embodiments, the intermediate end-effector pose is determined, at least in part, on a height of a distance sensor on a base of the mobile robot.

In some embodiments, controlling the mobile robot to grasp the object based, at least in part, on the determined pick trajectory includes detecting, as the manipulator is advanced along the pick trajectory, that a force associated with the manipulator exceeds a threshold value, and stopping advancing of the manipulator in response to determining that the force exceeds the threshold value. In some embodiments, controlling the mobile robot to grasp the object based, at least in part, on the determined pick trajectory further includes sensing, using a wrench sensor arranged on the manipulator, the force as a contact force between the manipulator and the object. In some embodiments, controlling the mobile robot to grasp the object based, at least in part, on the determined pick trajectory further includes activating one or more suction cups of a suction-based gripper coupled to the manipulator as the manipulator is advanced along the pick trajectory, and sensing as the force, a seal quality between one or more of the activated one or more suction cups and the object.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is an illustrative computing architecture for a robotic device that may be used in accordance with an illustrative embodiment of the invention.

FIG. 4 is a flowchart of a process for determining a grasp strategy based, at least in part, on uncertainty information, according to an illustrative embodiment of the invention.

FIG. 5A schematically illustrates a technique for representing extent uncertainty of an object, according to an illustrative embodiment of the invention.

FIG. 5B schematically illustrates a technique for classifying suction cups of a gripper based on the extent uncertainty shown in FIG. 5A.

FIG. 6A schematically illustrates an ambiguous object scenario in which the depth of a target object is unknown, according to an illustrative embodiment of the invention.

FIG. 6B schematically illustrates a process for sequentially engaging different suction cups of a gripper to grasp an object having an unknown extent, according to an illustrative embodiment of the invention.

FIG. 7 illustrates an architecture for a gripper controller including sub-controllers for suction cups having different classifications, according to an illustrative embodiment of the invention.

FIG. 8 schematically illustrates a process for sequentially activating suction cups based on a confidence of the suction cup sealing with an object to be grasped, according to an illustrative embodiment of the invention.

FIG. 9A illustrates an intermediate pose of a pick trajectory for an end effector of a robotic device, according to an illustrative embodiment of the invention.

FIG. 9B illustrates a terminal pose of a pick trajectory for an end effector of a robotic device, according to an illustrative embodiment of the invention.

FIG. 10 is a flowchart of a process for executing a pick trajectory based on uncertainty information about an extent and/or pose of an object to be grasped, according to an illustrative embodiment of the invention.

FIGS. 11A-11E illustrate a time sequence of a pick trajectory determined based, at least in part, on uncertainty information regarding an object to be grasped, according to an illustrative embodiment of the invention.

FIG. 12 illustrates an example configuration of a robotic device, according to an illustrative embodiment of the invention.

### DETAILED DESCRIPTION

To effectively grasp and move objects (e.g., boxes) from a first location (e.g., a stack of boxes inside of a truck) to a second location (e.g., a conveyor), a robot with a suction-based gripper coupled to a robotic arm may detect an object at the first location with one or more sensors of a perception system, control its robotic arm to place the gripper at a particular orientation in proximity to the object, grasp the object by activating one or more suction cups of the gripper, and move the object along a trajectory to the second location where the object is released from the gripper. When planning a grasp of an object, it may be important to consider both the extents of the object face to be grasped and the pose of the object face in space. For instance, the extents of the object face may be used to determine, at least in part, how to orient the gripper relative to the object face and/or to determine which suction cups of the suction-based gripper should be activated to grasp the object. The pose of the object face may be used, at least in part, to determine the configuration of the arm and/or gripper during approach towards the object prior to grasping the object.

Controlling the robot's manipulator to quickly approach and acquire suction on an object without imparting unnecessary force on the object may facilitate rapid pick-place cycles with a reduced risk of dropping objects while moving from the first location (e.g., the pick location) to the second location (e.g., the place location). Achieving a secure grasp on an object may result from engaging as many suction cups of the suction-based gripper as possible or desirable with the object. Securely grasping the object may be challenging when the pose of the object and/or one or more extents of the object are uncertain or unknown. Such sources of uncertainty may arise, for example, due to miscalibration of the robot's perception system resulting in measurement errors or from the inability of the robot's perception system to determine all extents (e.g., width, depth, height) of the object to be grasped. In a scenario where the extent(s) of the object are unknown or uncertain, the robot may be controlled to operate conservatively by, for example, activating only suction cups that are relatively certain to seal with the object face, which may result in a poor grasp of the object. Similarly, when the pose of the object face is unknown or uncertain, the robot may be controlled to operate conservatively to put the terminal placement of the gripper deep into the object, which could end up with striking the object with considerable force.

To this end, some embodiments of the present disclosure relate to informing grasping techniques implemented by a mobile robot based, at least in part, on uncertainty information associated with the extent(s) and/or pose of an object to be grasped. Providing context on extent and/or pose uncertainty to a gripper controller of the robot may enable the gripper controller to leverage different control strategies on a cup-by-cup basis, based, for example, on the anticipated confidence of a cup sealing successfully. Such strategies may appropriately balance trying to increase the number of active cups with maintaining appropriate vacuum pressure in the suction-based gripper.

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

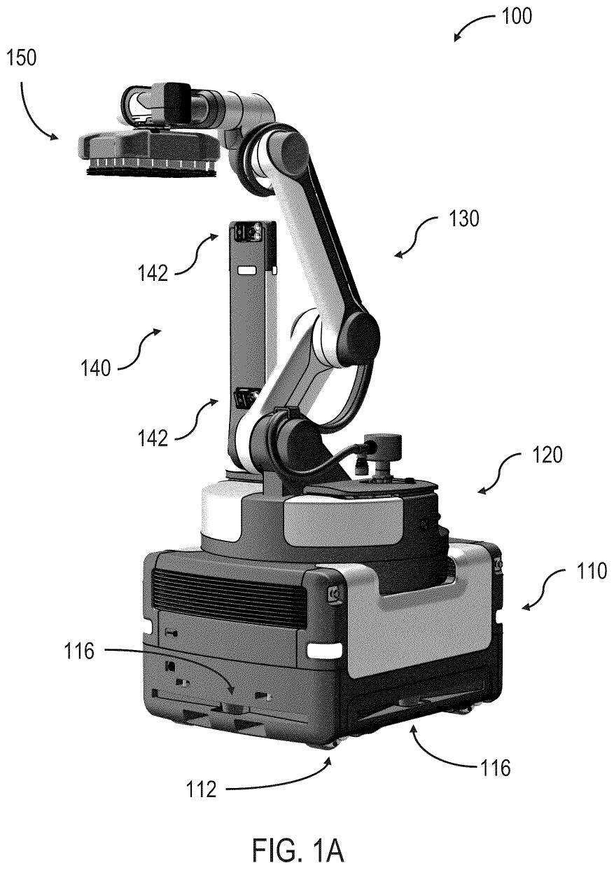

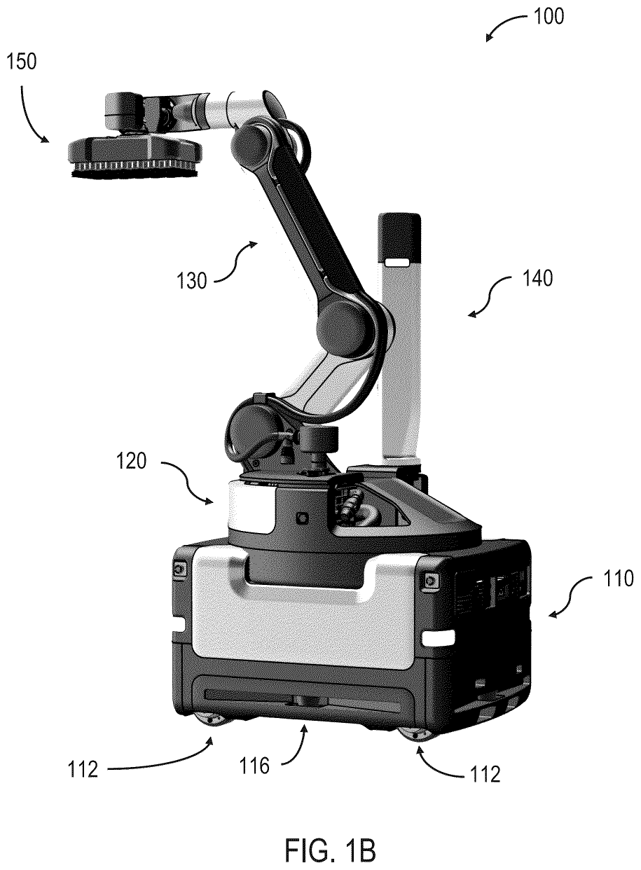

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

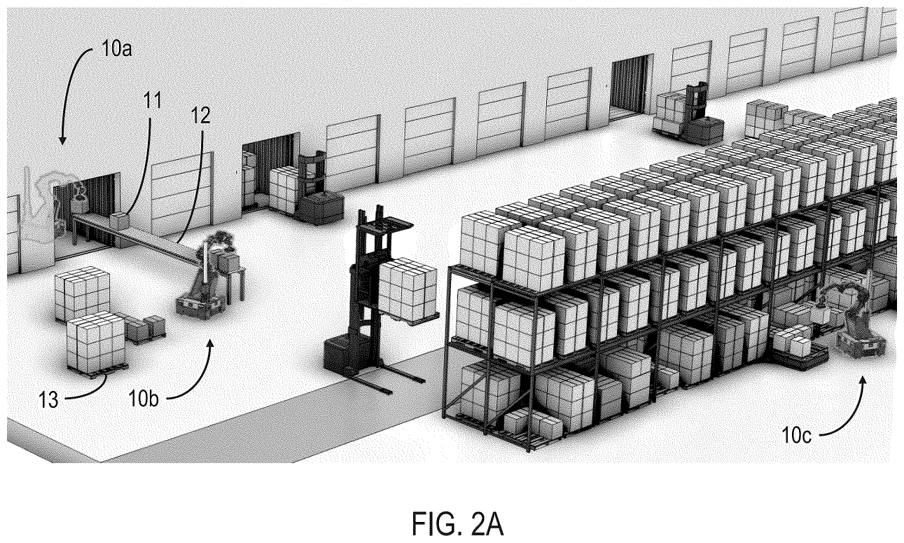

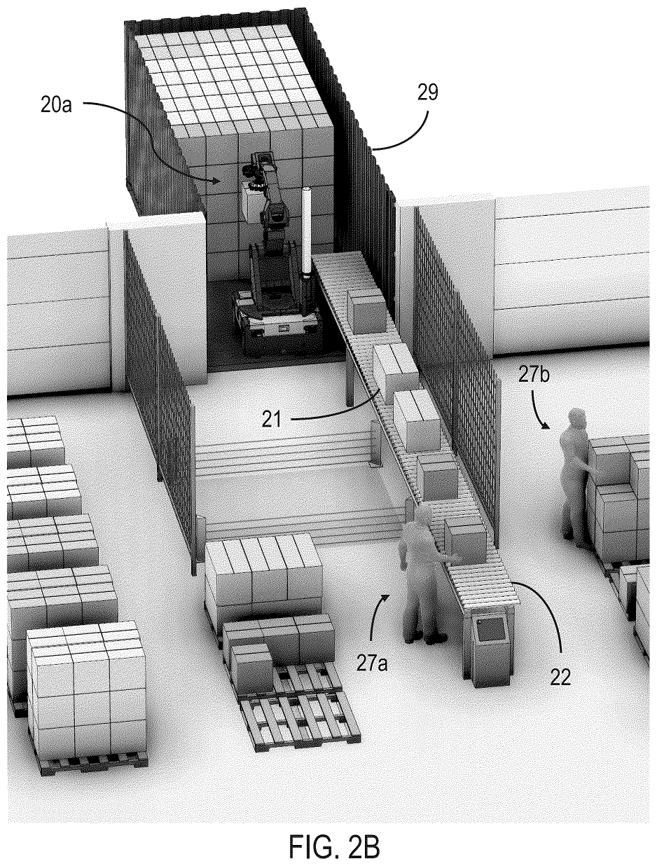

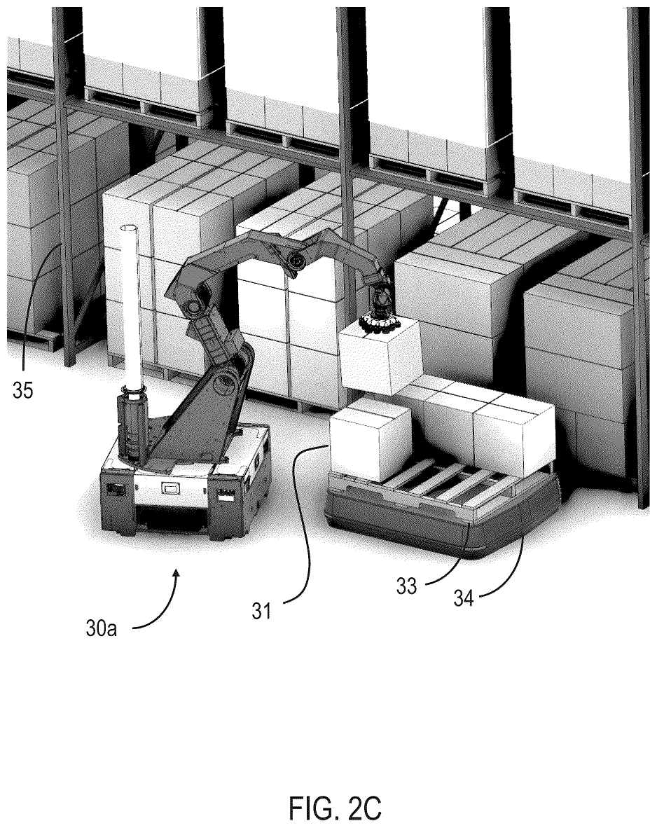

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

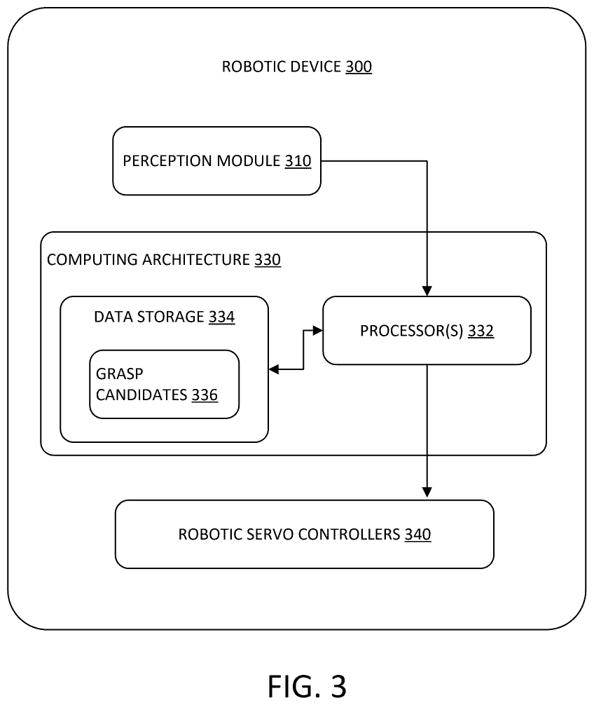

FIG. 3 illustrates an example computing architecture 330 for a robotic device 300, according to an illustrative embodiment of the invention. The computing architecture 330 includes one or more processors 332 and data storage 334 in communication with processor(s) 332. Robotic device 300 may also include a perception module 310 (which may include, e.g., the perception mast 140 and/or the distance sensors 116 shown and described above in FIGS. 1A-1B). The perception module 310 may be configured to provide input to processor(s) 332. For instance, perception module 310 may be configured to provide one or more images to processor(s) 332, which may be programmed to detect one or more objects in the provided one or more images for grasping by the robotic device. In some embodiments, perception module 310 may be configured to provide sensed information other than image data to processor(s) 332. For instance, information from distance sensors (e.g., distance sensors 166 described above in connection with FIGS. 1A-1B) may be provided to processor(s) 332, and the provided information may be used to detect one or more objects for grasping by the robotic device. Data storage 334 may be configured to store a set of grasp candidates 336 used by processor(s) 332 to represent possible grasp strategies for grasping a target object. Robotic device 300 may also include robotic servo controllers 340, which may be in communication with processor(s) 332 and may receive control commands from processor(s) 332 to move a corresponding portion of the robotic device. For example, after selection of a grasp candidate from the set of grasp candidates 336, the processor(s) 332 may issue control instructions to robotic servo controllers 340 to control operation of an arm and/or gripper of the robotic device to attempt to grasp the object using the grasp strategy described in the selected grasp candidate.

During operation, perception module 310 can perceive one or more objects (e.g., boxes) for grasping (e.g., by an end-effector of the robotic device 300) and/or one or more aspects of the robotic device's environment. In some embodiments, perception module 310 includes one or more sensors configured to sense the environment. For example, the one or more sensors may include, but are not limited to, a color camera, a depth camera, a LIDAR or stereo vision device, or another device with suitable sensory capabilities. In some embodiments, image(s) captured by perception module 310 are processed by processor(s) 332 using trained box detection model(s) to extract surfaces (e.g., faces) of boxes or other objects in the image capable of being grasped by the robotic device 300.

As discussed above, when using a robotic device to move objects from a first location to a second location in a pick-and-place operation, it is important that the object be securely grasped to reduce the risk of dropping the object during transit. However, obtaining a secure grasp on an object can be challenging if one or more extents of the object and/or the pose of the object are uncertain or unknown. Some embodiments of the present disclosure account for uncertainty in the extent and/or pose of an object to be grasped when planning and/or performing a grasp strategy implemented by a controller of the robot. The uncertainty-informed grasp strategy may enable the robot to achieve a more secure grasp on the object than if the uncertainty information was not taken into account. For example, the controller may use the uncertainty information to determine an approach (e.g., pick) trajectory of the robot's manipulator that reduces the risk of impacting the object with the gripper with too much force. Additionally or alternatively, the controller may use the uncertainty information to determine an activation strategy for particular suction cups of the gripper likely to achieve a secure grasp of the object. Examples of determining a grasp strategy based, at least in part, on uncertainty information associated with an object to be grasped by a mobile robot are described in more detail below.

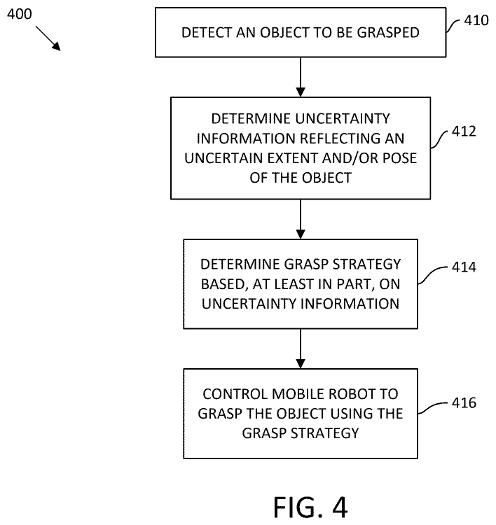

FIG. 4 illustrates a process 400 for controlling a mobile robot to grasp an object according to a grasp strategy that takes into account uncertainty information associated with the object, in accordance with some embodiments. Process 400 begins in act 410, where an object to be grasped by the mobile robot is detected. As described herein, a mobile robot may include a perception system (e.g., sensors included on perception mast 140, distance sensors 116 arranged on a mobile base of the robot, etc.). The perception system may be configured to capture information about the environment of the mobile robot including, but not limited to, potential objects to be grasped by the robot. For instance, one or more cameras arranged on the perception mast 140 may be configured to capture one or more images of a stack of boxes near the mobile robot, and the one or more images may be processed to detect at least some of the box faces in the stack to enable the mobile robot to grasp one or more of the boxes. In another example, the distance sensors 116 (e.g., LIDAR sensors) arranged on the mobile base of the robot may be configured to capture distance information (e.g., a 3D point cloud of distance information) surrounding the robot, and the distance information may be used to detect a box located on a surface near the base of the robot, which may be grasped by the robot. From among all of the detected objects in the environment, the mobile robot may be configured to select a target object for grasping next.

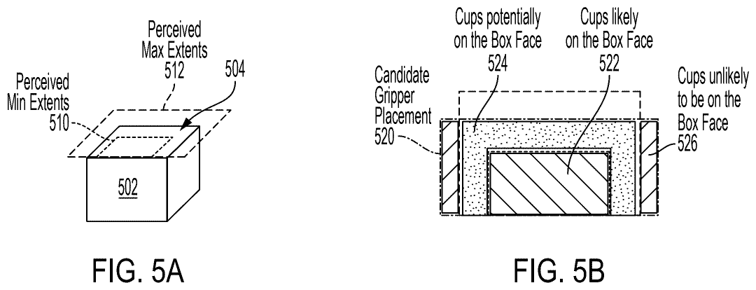

Process 400 then proceeds to act 412, where uncertainty information reflecting an uncertain extent and/or pose of the object is determined. The uncertainty information may be determined in any suitable way that enables a quantification of the uncertainty. For example, based on the initial detection of a box face, there may be regions of the box face that are more confidently a part of the true box face than others; mathematically this uncertainty could be represented as a pair of polygons-one describing each of the minimum and maximum extents (e.g., see FIG. 5A, described below), as a set of polygons representing different threshold levels of uncertainty, as a function defining uncertainty level as a function of suction cup pose relative to a object reference frame (e.g., with each suction cup or a gripper being assigned an uncertainty score), or using some other technique for quantifying uncertainty reflecting a particular extent and/or pose of the object to be grasped.

In an example where the perception system captures an image of a stack of boxes, a front face of a target box in the stack (e.g., the height and width of the boxes) may be determined with reasonable accuracy. However, the depth of the target box may not be known. In some embodiments, the robot may store a plurality of object “prototypes” (e.g., objects that the robot has observed before or is expected to observe in a particular situation such as unloading a truck), which describe the extents of the object. In such embodiments the depth of the target object may be inferred based on a matching of the extents of the front face of the target object with one of the stored prototypes. However, in some instances, multiple stored prototypes having different depth dimensions but the same or similar front extents may be stored leading to a scenario in which the depth dimension cannot be resolved based on the front face extents of the target object. In such a scenario, the prototype information may be used to quantify the uncertainty in the depth extent of the object, with a first prototype having a shorter depth representing a minimum extent and a second prototype having a longer depth representing a maximum extent. In some embodiments, the maximum extent may be set as corresponding to the largest object (e.g., the object having the longest depth dimension) that the mobile robot is expected to encounter or handle in a particular operating situation.

In another example where the perception system captures a 2D cross section of an object using distance sensors arranged on the mobile base of the robot, the width and depth of the object may be discernible from the captured distance measurements, but the height of the object may be unknown. In such instances, an uncertainty associated with the height extent of the object may be quantified based on information associated with one or more object prototypes and/or based on other information. For instance, a maximum height extent of the object may be determined based on a maximum allowable size of an object that can be grasped by the robot in a particular operating situation.

In both of the examples described above (and other examples not explicitly described herein), an extent uncertainty for an object may be particularly relevant to grasping the object when the object face to be grasp includes the uncertain or unknown extent. For example, if the depth dimension of the top face of a box is unknown or uncertain, determining a gripper placement relative to the top face of the box and/or determining which suction cups in a suction-based gripper should be activated to grasp the box to achieve a success top pick of the box may be challenging. In the example of an object located on a surface near the base of the robot in which the height dimension is unknown or uncertain, it may be challenging to know how to determine a terminal pose of a pick trajectory of the gripper as it approaches the object without having the gripper collide into the object with force, which may damage the object.

After uncertainty information has been determined (e.g., quantified), process 400 proceeds to act 414, where a grasp strategy is determined based, at least in part, on the uncertainty information determined in act 412. Determining a grasp strategy may include any of a number of operations involved with grasping the object including, but not limited to determining a pick trajectory, determining a terminal pose of the gripper prior to grasping the object, determining a gripper placement on the object to grasp the object, determining which suction cups of the gripper to activate, and when to activate certain suction cups of the gripper in an effort to achieve a secure grasp. Non-limiting examples of determining a grasp strategy that takes into account uncertainty information are described in more detail below.

Process 400 then proceeds to act 416, where the mobile robot is controlled to grasp the object using the grasp strategy determined in act 414. For example, when determining the grasp strategy includes determining all or a portion of a pick trajectory, the arm and/or end effector of the robot may be controlled in act 416 according to the determined pick trajectory. As another example, when determining the grasp strategy includes determining which suction cups to activate and/or when to activate particular suction cups of the gripper, the vacuum system of the robot may be controlled in act 416 to activate particular suction cups according to the determined cup activation strategy. In some embodiments, determining a grasp strategy may include both determining a pick trajectory and determining a cup activation strategy, and one or more controllers of the mobile robot may be instructed to control the robot according to the determined grasp strategy. For instance, the grasp strategy may entail activating certain suction cups of the gripper prior to contact between the gripper and the object, and activating additional suction cups of the gripper as the object continues through the terminal portion of the pick trajectory to achieve a secure grasp on the object.

FIG. 5A schematically illustrates a technique for quantifying an unknown extent of an object, in accordance with some embodiments of the present disclosure. The object may be a box with a front face 502 and a top face 504. The height and width extents of the box may be determined based on an image of front face 502 captured by the perception system of the robot. Although the width extent of the box for the top face 504 is shared with the front face 502, the depth dimension of the top face 504 may be uncertain or unknown as it may not be discernable from the image captured by the perception system of the robot. If the box is to be grasped using a top pick, the uncertain depth dimension may be important to consider when determining a grasp strategy.

Alternatively, the box may be detected as a horizontal 2D slice of points in space using one or more distance sensors (e.g., one or more LIDAR sensors) arranged on a base of the mobile robot. In such a scenario, even if the front face 502 may be detected by the distance sensors, it may be challenging to determine the exact width of the box because it may be difficult to identify exactly where the vertical edges are from the horizontal 2D slice. The depth of the box may or may not be discernible depending on the yaw of the box with respect to the sensor(s). The height of the box may be inferred as being at least as high as the height of the distance sensor(s) on the robot, but could possibly be higher.

In the example of FIG. 5A, the uncertainty for the depth extent of the box may be quantified using a pair of polygons. Polygon 510 represents minimum extents of the top face 504 of the box and polygon 512 represents maximum extents of the top face 504, where the uncertainty is captured in the difference between the two polygons. Although the top face 504 and the front face 502 of the object share a width dimension, polygon 510 may include a smaller width dimension than the width dimension for front face 502 to accommodate other sources of uncertainty (e.g., robot measurement error). Alternatively, the width dimension may also have some uncertainty, as described above, when the box is detected using one or more distance sensors. Similarly, polygon 512 may include a larger width dimension than the width dimension for the front face 502 to capture uncertainty in the width dimension.

As described herein, the information used to describe the extents of the polygon 510 and 512 may be determined from one or more stored object prototypes or may be determined from any other suitable information (e.g., the maximum box size that the mobile robot is expected to encounter in a particular operation environment). Although the polygons represented in FIG. 5A are used to represent uncertain extents on the top face 504 of the object, it should be appreciated that a similar representation may be used to quantify uncertainty in extents on any other surface of the object to be grasped by the robotic device. Additionally, although only two polygons representing the minimum and maximum extents for top face 504 are shown, it should be appreciated that more than two polygons may be used to quantify uncertainty of one or more extents of an object face, and embodiments are not limited in this respect. Additionally, uncertainty in extents may be quantified in some embodiments using a technique that does not involve polygons. For instance, uncertainty may be quantified as a function of position.

After the uncertainty for an object face has been quantified (e.g., using the multiple-polygon approach shown in FIG. 5A), the uncertainty information may be used to associate classifications with suction cups of the gripper. An example of performing cup classification based on uncertainty information is shown in FIG. 5B. FIG. 5B schematically illustrates a top-down view of the box shown in FIG. 5A. A candidate gripper placement 520 arranged to grasp the top face of the box is shown and suction cups of the gripper may be classified using the uncertainty information captured by the polygons shown in FIG. 5A. In the example of FIG. 5B, suction cups likely to engage with the top face of the box form a first subset 522 of cups corresponding to polygon 510 shown in FIG. 5A. Suction cups having a potential to engage with the top face of the box form a second subset 524 of cups and correspond to cups that fall outside of polygon 510 but within polygon 512 of FIG. 5A (i.e., cups falling between the min and max extents). Suction cups falling outside of the polygon 512 of FIG. 5A (i.e., outside of max extents) may be classified into a third subset 526 of cups. By classifying suction cups based on uncertainty information, the cups most likely to engage with the face of the object (e.g., cups in first subset 522) may be activated initially and the cups less likely to engage with the face of the object (e.g., cups in second subset 524) may be activated later in an effort to improve the grasp of the object. Cups that are unlikely to engage with the face (e.g., cups in third subset 526) may not be activated at all given their low probability of improving the grasp of the object.

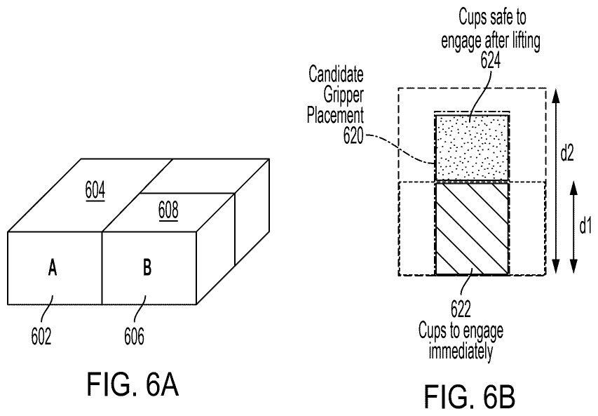

If objects are in close proximity, their perceived extents may overlap or be unknown in one or more axes; in such a situation, it may be useful to classify cups on an additional axis describing when they should be activated. For instance, in some scenarios it may be advantageous to initially activate suction cups confidently on the target object face and then activate additional cups once the object has been lifted from neighboring objects. As described above, in some embodiments a mobile robot may store a plurality of object prototypes that describe extents for a plurality of objects that the mobile robot is expected to encounter or has encountered in the past. At least some of the store object prototypes may have the same or similar front face extents but different depth extents. FIG. 6A schematically illustrates an example of a scenario in which two boxes—box A and box B—have similar front face extents but different depth extents. That is, a first front face 602 of box A has similar dimensions as a second front face 606 of box B. However, the depth extent for the top face 604 of box A is longer than the depth extent for the top face 608 of box B. When detected from the front, boxes A and B may be indistinguishable and the depth extent may be considered unknown.

When performing a top pick a conservative grasp strategy may be to always assume that the target object is the prototype having the smallest depth dimension so as not to unintentionally grasp another object located behind the target object (e.g., the box located behind box B). However, using that conservative approach may result in a poor grasp if the target object to be grasped is box A. FIG. 6B schematically illustrates a technique for using uncertainty information to achieve a secure grasp on an object regardless of whether the object to be grasped is box A or box B in the example of FIG. 6A. FIG. 6B shows a top down view of one of the boxes (i.e., box A or box B) in the example of FIG. 6A. A gripper candidate placement 620 relative to the top face of the box is shown. The box having a shorter depth dimension (box B in the example of FIG. 6A) may have a depth d1 and the box having a larger depth dimension (box A in the example of FIG. 6A) may have a depth d2. Regardless of whether the target box to grasp is box A or box B, the cups within subset 622 corresponding to the prototype with depth dimension d1 should engage with the surface of the box to be grasped. Accordingly, the cups in subset 622 may initially be activated and the box may be lifted. After lifting the box, the cups in subset 624 (e.g., all or a portion of cups in subset 624) may be activated. If the box being lifted is box A, the activation of cups in subset 624 may provide a more secure grasp of the box. If the box being lifted is box B, the cups in subset 624 may fail to engage with a surface of an object and may be deactivated because they do not contribute to grasp of box B.

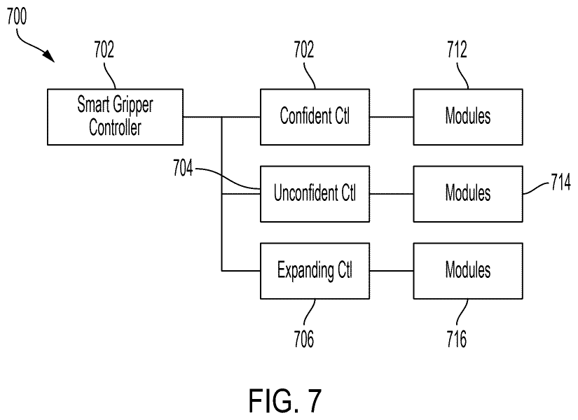

To plan an effective grasp of an object, the cups on a box face can be separated into distinct groupings. In the example of FIG. 6B, all cups in subset 622 may be activated initially and all cups in subset 624 may be activated after the object is lifted a certain distance in an effort to achieve a secure grasp of the object. The inventors have recognized and appreciated that mobile robots have a finite amount of power and/or vacuum pressure available to activate cups in the gripper. Due to these limitations activating all cups in a large subset of cups may not provide the best opportunity to achieve a secure grasp of the object. FIG. 7 illustrates an example architecture 700 of a gripper controller for a mobile robot, in accordance with some embodiments of the present disclosure. As shown, architecture 700 for a gripper controller may be associated with a set of sub-controllers running in parallel with corresponding modules for performing various control operations (e.g., leak detection, cup retrying, etc.) associated with the suction cups of the gripper. Each of the sub-controllers and its corresponding modules may be associated with cups having a different confidence level of achieving a seal with the object surface. For instance, architecture 700 includes a confident sub-controller 702 and associated first modules 712 and an unconfident sub-controller 704 and associated second modules 714. Architecture 700 also includes an expanding sub-controller 706 and associated third modules 716. The modules (e.g., first modules 712, second modules 714, third modules 716) may be different and/or tuned based on the confidence of the associated cups. For example, unconfident sub-controller 704 may be configured to instruct modules 714 to perform leak detection, but to use fewer cup retrying attempts compared to cups classified as confident. In this way, unconfident cups may be associated with more strict control strategies, which may result in an overall better vacuum on the grasped object through the remaining cups (e.g., cups associated with a higher confidence).

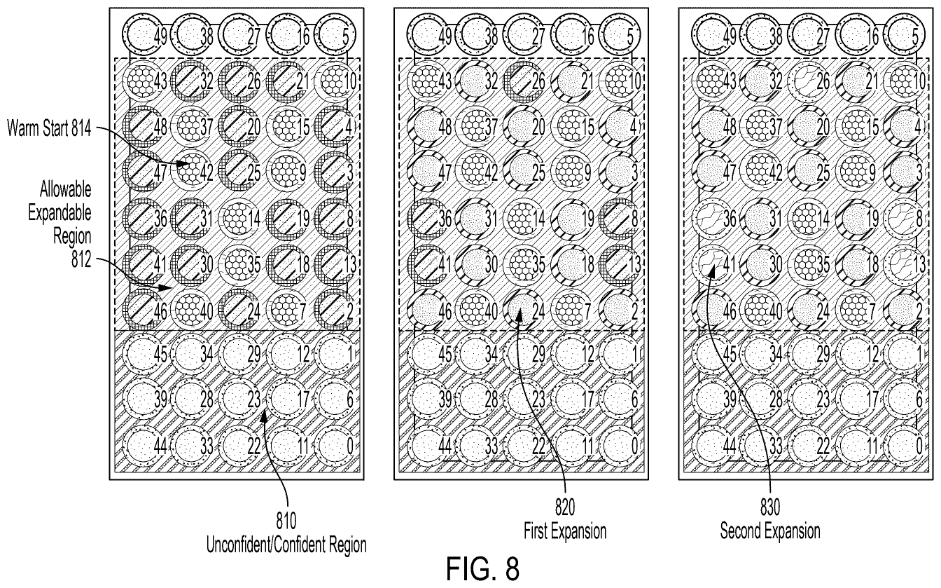

In some embodiments, the subsets of cups associated with the different sub-controllers may be determined based, at least in part, on the uncertainty information as described herein. FIG. 8 schematically illustrates different groupings of cups into subsets based on uncertainty information, in accordance with some embodiments of the present disclosure. As shown, a first subset 810 of cups may include cups within the minimum uncertain extent polygon (e.g., polygon 510 illustrated in FIG. 5A). As such, cups in the first subset 810 may represent cups with a high confidence that they will engage with the object face, and may be controlled by either the confident sub-controller 702 or the unconfident sub-controller 704.

As shown in FIG. 8, a second subset 812 of cups may be associated with an allowable expandable region of the gripper. The cups in the second subset 812 may include cups outside the minimum uncertain extent polygon (e.g., polygon 510 illustrated in FIG. 5A) and inside the maximum uncertain extent polygon (e.g., polygon 512 illustrated in FIG. 5A). As such, cups in the second subset 812 may represent cups with a lower confidence that they will engage with the object face than cups in the first subset 810, and may be controlled by expanding sub-controller 706.

Rather than activating all cups within the second subset 812 simultaneously, the inventors have recognized that it may be advantageous (e.g., due to limited power and/or pressure requirements for a mobile robot) to activate the cups in the second subset 812 in stages with the goal of obtaining as many sealed cups as possible.

To gather information on the unknown extent of the surface being grasped, the cups in the second subset 812 may be used. As shown in FIG. 8, at a first point in time (e.g., simultaneously with or shortly after controlling the cups in first subset 810 of cups), a third subset 814 of cups within the second subset 812 of cups may be activated to probe the ability of cups in the unknown or uncertain extent to seal to the surface of the object being grasped. The cups in the third subset 814 may form a pattern of cups within the second subset 812. In some embodiments, the pattern of cups may be a function of the gripper's orientation relative to the surface of the object. An example of one such pattern shown in FIG. 8 is a cross or “X” pattern, which may allow for suction of the gripper to be robust against the yaw angle between the gripper and the object. Another example of pattern is parallel lines of cups, which may be used when there is a rough estimate of the depth of the surface. In some embodiments, the pattern of cups in the third subset 814 may be determined based, at least in part, on an amount of available system pressure for the robot. In some embodiments, the pattern of cups in the third subset 814 may be determined based, at least in part, on an amount of flow allowed through the suction-based gripper. In some embodiments, the pattern may extend along a wide area across the second subset 812 of cups to try and achieve a grasp of the object that resists moments imposed by the weight of the object (e.g., by sealing cups that are farther apart).

After activating the cups in the third subset 814, the cups in the third subset 814 may be monitored for sealing to the surface and if a seal quality of a cup in the third subset 814 is greater than a threshold seal quality, one or more cups neighboring the cup with a quality seal may be activated to expand the set of cups activated in the second subset 812. Cups in the third subset 814 that do not achieve a quality seal with the surface of the object (e.g., by having a seal quality less than a threshold seal quality) may be deactivated. FIG. 8 shows a first expansion of cups in which a fourth subset 820 of cups within the second subset 812 of cups is activated. In the example shown in FIG. 8, all of the cups in the third subset 814 achieved a quality seal. Accordingly, in the first expansion, all cups neighboring cups in the third subset 814 are included in the fourth subset 820 during the first expansion. It should be appreciated however, that if one or more of the cups in the third subset 814 had failed to achieve a quality seal, those cup(s) may be deactivated and cups neighboring the deactivated cups may not be included in the fourth subset 820.

After activating the cups in the fourth subset 820, the cups in the fourth subset 820 (and possibly also the cups remaining activated in the third subset 814) may be monitored for sealing to the surface and if a seal quality of a cup in the fourth subset 820 is greater than a threshold seal quality, one or more cups neighboring the cup with a quality seal may be activated to expand the set of cups activated in the second subset 812. Cups in the fourth subset 820 that do not achieve a quality seal with the surface of the object (e.g., by having a seal quality less than a threshold seal quality) may be deactivated. FIG. 8 shows a second expansion of cups in which a fifth subset 830 of cups within the second subset 812 of cups is activated. In the example shown in FIG. 8, all of the cups in the fourth subset 820 achieved a quality seal. Accordingly, in the second expansion, all cups neighboring cups in the fourth subset 820 are included in the fifth subset 830 during the second expansion. It should be appreciated however, that if one or more of the cups in the fourth subset 820 had failed to achieve a quality seal, those cup(s) may be deactivated and cups neighboring the deactivated cups may not be included in the fifth subset 830.

As shown in FIG. 7, the gripper controller architecture may include a separate sub-controller (e.g., expanding sub-controller 706) associated with modules (e.g., third modules 716), which enables the gripper controller to perform various control operations (e.g., leak detection, cup retrying, etc.) for cups included in the expansion processes shown in FIG. 8 that may be different than those used for cups included in confident or unconfident regions of the gripper. It should also be appreciated that although only two expansion steps are shown in FIG. 8, any suitable number of expansion steps may be used, and the number of expansion steps may depend, at least in part, on the initial pattern used for the third subset 814 and characteristics of the size of the surface of the object being grasped (e.g., size of the object, ability of the surface to create a quality seal with the cups, etc.), among other factors. By utilizing the ability for the gripper to expand the groups of cups outwards, the gripper may quickly obtain more cups with quality seals, while also minimizing the pressure (obtaining stronger vacuum) in the manifold of the gripper throughout the grasp acquisition.

It should be appreciated that the cup expansion process shown in FIG. 8 may be performed at any suitable time. For instance, expansion may occur both pre- and post-lift of the object. When expanding post-lift, it may be particularly important to minimize the pressure loss across the manifold of the suction gripper to maintain a robust grasp on the object. Accordingly, the process of expanding cups pre-lift and post-lift may be different in that the post-lift expansion process may be more conservative than the pre-lift expansion process. In other embodiment, the post-lift expansion process may be more conservative than the pre-lift expansion process if the mobile robot detects that grasp on the object is weakening in an attempt to provide a more robust grasp of the object.

In some embodiments, the region bounded by the cups having a quality seal after expansion may be used to determine the unknown extent of the object. For instance, a new object prototype having one or more extents corresponding to the grasped object may be stored by the mobile robot for use in grasping future objects, one or more stored object prototypes may be removed from the store plurality of prototypes, etc. In some embodiments, the determined extent that was previously unknown may be used in other ways. For instance, can be desirable to place objects on a conveyor such that their longest axis is along the travel direction of the conveyor. If the determined extent is determined to be the longest dimension of the object, that information may be used to determine or modify a place operation of the object once at its destination (e.g., by orienting the long axis of the object along the travel direction of the conveyor when the destination is a conveyor).

As described above, determining a grasp strategy based on an uncertain or unknown extent and/or pose of an object to be grasped may include determining a pick trajectory plan used to approach the object prior to contact. In some situations, the grasp plane may be bounded but its position in space (e.g., its pose) may not be perceived. For example, when a 2D cross section of an object is detected via horizontal 2D lidar sensors (e.g., arranged on the mobile base of the robot), the width and depth of the object (e.g., bounding the grasp plane) may be known with reasonable certainty, but the height of the object (e.g., the height of the grasp plane when top picking) may be unknown. In such a situation, the grasp arm configuration may be conservatively planned assuming the object is no taller than the level of the lidar sensors, relying on a robust approach and contact strategy to quickly achieve a secure grasp on the object. However, such a conservative approach may not work well if the height of the object is appreciably different than the height of the lidar sensors. To this end, some embodiments of the present disclosure relate to determining at least a portion of a pick trajectory based, at least in part, on uncertainty information regarding an extent and/or pose of the object to be grasped.

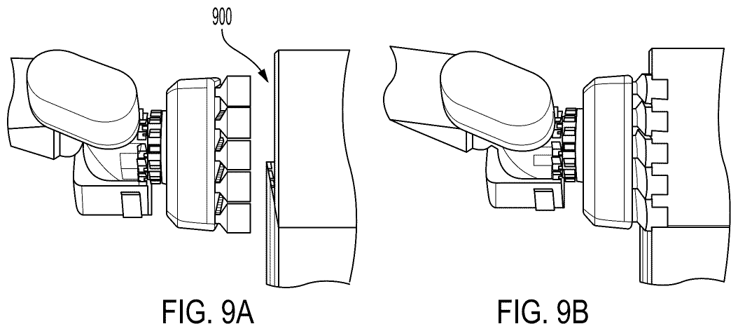

In some embodiments, a pick trajectory plan may receive a grasp surface location, which describes the terminal end-effector pose as part of the pick motion of the robot's arm. The inventors have recognized and appreciate that when this terminal pose is uncertain or unknown, it may be helpful to add flexibility into the pick trajectory plan. In some embodiments, a terminal end-effector pose may be planned beyond the perceived grasp surface. An example of such a terminal end-effector pose is shown in FIG. 9B. The terminal end-effector pose may be located within the perceived object to account for uncertainty in the pose of the object. In some embodiments, the magnitude of the pick trajectory modification may be proportional to the uncertainty of the grasp surface pose. For example, if the grasp surface location is known within some error, an offset may be applied to the terminal end-effector pose that reflects the error. In some embodiments, if the grasp surface location is unknown, the terminal end-effector pose may be extended to the nearest collision object, such as the ground plane, or up to the maximum reach of the manipulator.

An intermediate end-effector pose may then be selected for the pick trajectory. An example of an intermediate end-effector pose is shown in FIG. 9A. As shown, the end effector is shown some distance 900 from the surface of the object to be grasped. In some embodiments, the intermediate end-effector pose may satisfy the following criteria: it is clear of any obstacles, and can reach the terminal end-effector pose selected above by following a straight line at a constant orientation. In some embodiments, if the grasp surface location is unknown, a buffer offset from the terminal end-effector pose object plus the largest expected box dimension may be used as the intermediate pose.

After determining the terminal end-effector pose and the intermediate end-effector pose, a pick trajectory planner module of the mobile robot may incorporate an end-effector twist tracking objective and/or constraint module. The purpose of the twist tracking objective and/or constraint module may be to track the path of the manipulator from the intermediate end-effector pose to the terminal end-effector pose while following a target twist with a constant angular component, up to and including the terminal end-effector pose. In some embodiments, using twist tracking may ensure one or more of the following:
the object surface will be contacted with some bounded end-effector twist, which places implicit bounds on contact forces. This may be particularly helpful for face-picking light boxes and/or unsupported boxes, as such boxes may easily be pushed backwards by large impact forces.
any grasp surface pose uncertainty is tolerated in the pick trajectory planner, and with the only limit being imposed by the reach of the manipulator.
the gripper is flat against the object surface at the time of contact due to the zero angular twist.
robustness to environment uncertainty without compromising trajectory speed due to the ability to use a variable twist target, which slows down as the area of uncertainty is further penetrated by the end-effector.

After the pick trajectory has been determined (e.g., planned by the pick trajectory planner module), the pick trajectory may be executed, and a wrench sensor on the end-effector may be monitored to detect contact with the surface of the object to be grasped. Once contact is detected, the remainder of the pick trajectory may be aborted, e.g., by freezing the manipulator arm in place. In some embodiments, the previously unknown extent of the object being grasped may be updated according to the measured end-effector pose at the time of detected contact.

Some benefits of the controlled-end-effector-twist approach described herein include allowing the execution of the entire pick trajectory using stiff joint-space control rather than having to perform controller switching sometimes required with approaches that do not use the techniques described herein. By not requiring controller switching, planning through arm singularities, and hence the ability to make unrestricted use of the manipulator's workspace may be achieved.

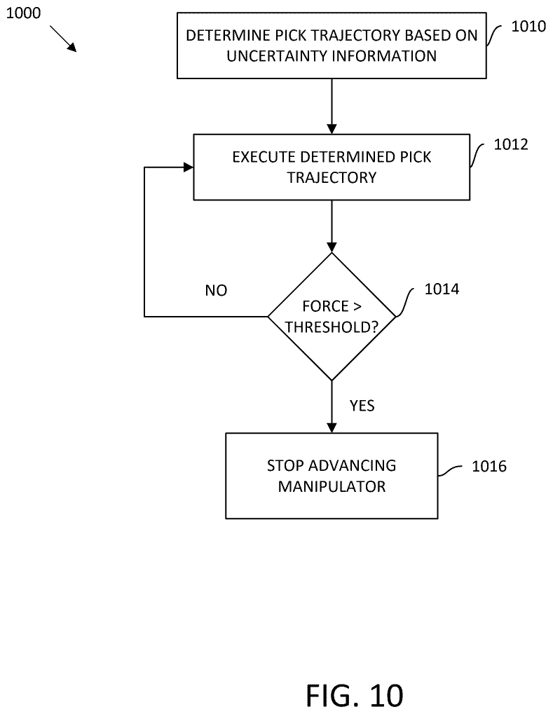

FIG. 10 illustrates a flowchart of a process 1000 for using a pick trajectory to grasp an object that takes into account an uncertain or unknown pose of an object surface to be grasped. Process 1000 begins in act 1010, where a pick trajectory is determined based on uncertainty information (e.g., pose uncertainty information) about a surface of an object to be grasped. For instance, as described in connection with FIGS. 9A and 9B, a terminal end-effector pose and an intermediate end-effector pose of the pick trajectory may be determined based on the uncertainty information. After the terminal end-effector pose and intermediate end-effector pose are determined, a pick trajectory planner module may use an end-effector twist tracking objective and/or constraint module to plan the portion of the pick trajectory from the intermediate end-effector pose to the terminal end-effector pose such that the pick trajectory follows a target twist with a constant angular component, up to and including the terminal end-effector pose.

After the pick trajectory is determined, process 1000 proceeds to act 1012, where the mobile robot is controlled to execute the determined pick trajectory. As the manipulator is advanced toward the terminal end-effector pose, a force (e.g., a contact force sensed by a wrench sensor on the end effector) may be monitored to detect contact of the end effector with the surface of the object to be grasped. As shown in FIG. 10, process 1000 may proceed to act 1014, where it is determined whether the measured force is greater than a threshold value. If it is determined that the force is less than the threshold value, process 1000 returns to act 1012, where the mobile robot may continue to be controlled to advance the manipulator toward the terminal end-effector pose according to the pick trajectory. If it is determined in act 1014 that the force is greater than the threshold value, process 1000 proceeds to act 1016, where the manipulator is not advanced any further based on the detected contact between the end-effector and the surface of the object to be grasped. In some embodiments, vacuum may be supplied to activate one or more cups in the suction-gripper (e.g., cups in a high confidence region of the gripper) as the gripper is approaching the surface of the object to be grasped, and a seal quality between the activated cups and the surface of the object being grasped may additionally or alternatively be used to a contact force in act 1014 when deciding when to stop advancing the manipulator toward the target object surface.

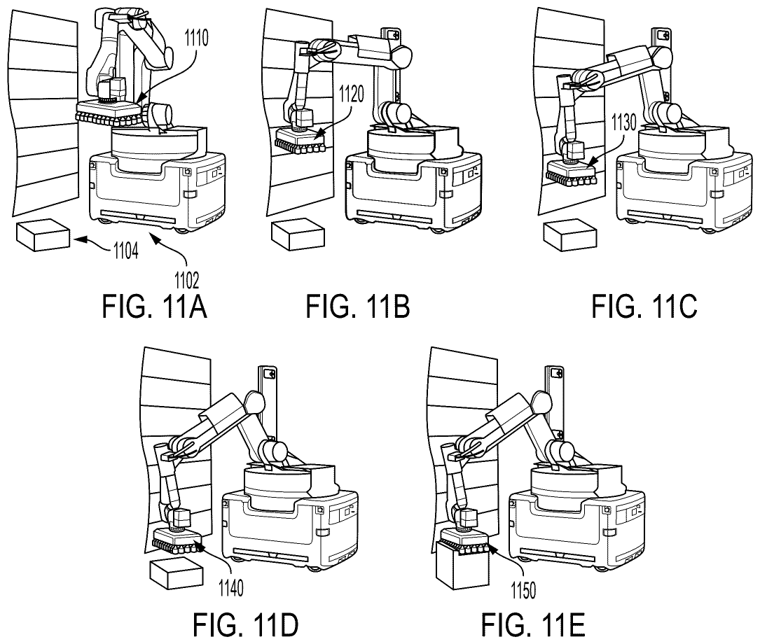

FIGS. 11A-11E schematically illustrates a sequence of timepoints in a controlled-twist approach for a pick trajectory that takes into account uncertainty information, in accordance with some embodiments of the present disclosure. In FIG. 11A, one or more distance sensors 1102 arranged on a base of a mobile robot detect an object 1104 (e.g., a box) located on a surface near the base of the mobile robot. Although the distance sensor(s) 1102 may determine the width and the depth of the object 1104, the height of the object 1104 may be unknown. A manipulator of the mobile robot may have a first pose 1110 when the object 1104 is detected as shown in FIG. 11A. FIG. 11B shows the manipulator having a second pose 1120 that corresponds to an intermediate end-effector pose of a pick trajectory determined based on uncertainty information about the pose of the top surface of object 1104 to be grasped. FIG. 11C shows the manipulator having a third pose 1130 as the manipulator is advanced between the second pose 1120 according to the pick trajectory. FIG. 11D shows the manipulator having a fourth pose 1140 during which the contact with the surface of the object is detected. FIG. 11D shows the manipulator having fifth pose 1150 after the manipulator has contacted the surface of the object and begins to grasp the object, for example, by activating suction for one or more cups of the suction-based gripper. In some embodiments, the cups of the gripper may be activated based, at least in part, on one or more of the techniques described herein. Once contact is made with the surface of the object, the unknown height of the object, described previously, may be updated to the height at which the manipulator is deemed to have contacted the object.

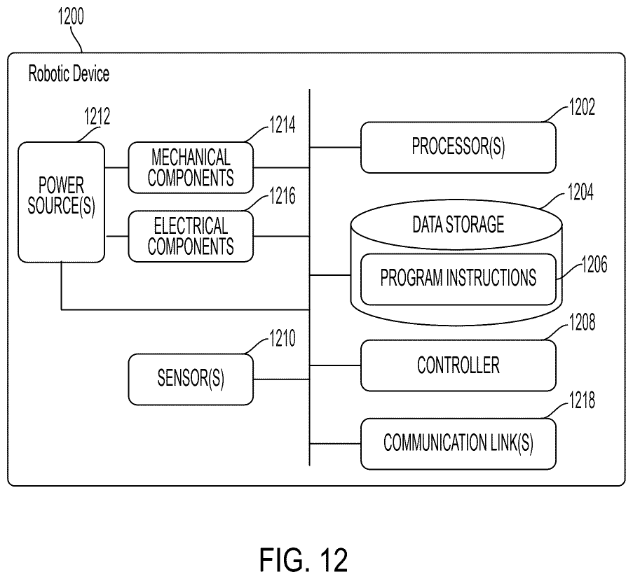

FIG. 12 illustrates an example configuration of a robotic device 1200, according to an illustrative embodiment of the invention. An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device).

In some implementations, the robotic device may include force sensors that measure or estimate the external forces (e.g., the force applied by a limb of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

FIG. 12 illustrates an example configuration of a robotic device (or “robot”) 1200, according to an illustrative embodiment of the invention. The robotic device 1200 represents an example robotic device configured to perform the operations described herein. Additionally, the robotic device 1200 may be configured to operate autonomously, semi-autonomously, and/or using directions provided by user(s), and may exist in various forms, such as a humanoid robot, biped, quadruped, or other mobile robot, among other examples. Furthermore, the robotic device 1200 may also be referred to as a robotic system, mobile robot, or robot, among other designations.

As shown in FIG. 12, the robotic device 1200 includes processor(s) 1202, data storage 1204, program instructions 1206, controller 1208, sensor(s) 1210, power source(s) 1212, mechanical components 1214, and electrical components 1216. The robotic device 1200 is shown for illustration purposes and may include more or fewer components without departing from the scope of the disclosure herein. The various components of robotic device 1200 may be connected in any manner, including via electronic communication means, e.g., wired or wireless connections. Further, in some examples, components of the robotic device 1200 may be positioned on multiple distinct physical entities rather on a single physical entity. Other example illustrations of robotic device 1200 may exist as well.

Processor(s) 1202 may operate as one or more general-purpose processor or special purpose processors (e.g., digital signal processors, application specific integrated circuits, etc.). The processor(s) 1202 can be configured to execute computer-readable program instructions 1206 that are stored in the data storage 1204 and are executable to provide the operations of the robotic device 1200 described herein. For instance, the program instructions 1206 may be executable to provide operations of controller 1208, where the controller 1208 may be configured to cause activation and/or deactivation of the mechanical components 1214 and the electrical components 1216. The processor(s) 1202 may operate and enable the robotic device 1200 to perform various functions, including the functions described herein.

The data storage 1204 may exist as various types of storage media, such as a memory. For example, the data storage 1204 may include or take the form of one or more computer-readable storage media that can be read or accessed by processor(s) 1202. The one or more computer-readable storage media can include volatile and/or non-volatile storage components, such as optical, magnetic, organic or other memory or disc storage, which can be integrated in whole or in part with processor(s) 1202. In some implementations, the data storage 1204 can be implemented using a single physical device (e.g., one optical, magnetic, organic or other memory or disc storage unit), while in other implementations, the data storage 1204 can be implemented using two or more physical devices, which may communicate electronically (e.g., via wired or wireless communication). Further, in addition to the computer-readable program instructions 1206, the data storage 1204 may include additional data such as diagnostic data, among other possibilities.

The robotic device 1200 may include at least one controller 1208, which may interface with the robotic device 1200. The controller 1208 may serve as a link between portions of the robotic device 1200, such as a link between mechanical components 1214 and/or electrical components 1216. In some instances, the controller 1208 may serve as an interface between the robotic device 1200 and another computing device. Furthermore, the controller 1208 may serve as an interface between the robotic device 1200 and a user(s). The controller 1208 may include various components for communicating with the robotic device 1200, including one or more joysticks or buttons, among other features. The controller 1208 may perform other operations for the robotic device 1200 as well. Other examples of controllers may exist as well.

Additionally, the robotic device 1200 includes one or more sensor(s) 1210 such as force sensors, proximity sensors, motion sensors, load sensors, position sensors, touch sensors, depth sensors, ultrasonic range sensors, and/or infrared sensors, among other possibilities. The sensor(s) 1210 may provide sensor data to the processor(s) 1202 to allow for appropriate interaction of the robotic device 1200 with the environment as well as monitoring of operation of the systems of the robotic device 1200. The sensor data may be used in evaluation of various factors for activation and deactivation of mechanical components 1214 and electrical components 1216 by controller 1208 and/or a computing system of the robotic device 1200.

The sensor(s) 1210 may provide information indicative of the environment of the robotic device for the controller 1208 and/or computing system to use to determine operations for the robotic device 1200. For example, the sensor(s) 1210 may capture data corresponding to the terrain of the environment or location of nearby objects, which may assist with environment recognition and navigation, etc. In an example configuration, the robotic device 1200 may include a sensor system that may include a camera, RADAR, LIDAR, time-of-flight camera, global positioning system (GPS) transceiver, and/or other sensors for capturing information of the environment of the robotic device 1200. The sensor(s) 1210 may monitor the environment in real-time and detect obstacles, elements of the terrain, weather conditions, temperature, and/or other parameters of the environment for the robotic device 1200.

Further, the robotic device 1200 may include other sensor(s) 1210 configured to receive information indicative of the state of the robotic device 1200, including sensor(s) 1210 that may monitor the state of the various components of the robotic device 1200. The sensor(s) 1210 may measure activity of systems of the robotic device 1200 and receive information based on the operation of the various features of the robotic device 1200, such the operation of extendable legs, arms, or other mechanical and/or electrical features of the robotic device 1200. The sensor data provided by the sensors may enable the computing system of the robotic device 1200 to determine errors in operation as well as monitor overall functioning of components of the robotic device 1200.

For example, the computing system may use sensor data to determine the stability of the robotic device 1200 during operations as well as measurements related to power levels, communication activities, components that require repair, among other information. As an example configuration, the robotic device 1200 may include gyroscope(s), accelerometer(s), and/or other possible sensors to provide sensor data relating to the state of operation of the robotic device. Further, sensor(s) 1210 may also monitor the current state of a function that the robotic device 1200 may currently be operating. Additionally, the sensor(s) 1210 may measure a distance between a given robotic limb of a robotic device and a center of mass of the robotic device. Other example uses for the sensor(s) 1210 may exist as well.

Additionally, the robotic device 1200 may also include one or more power source(s) 1212 configured to supply power to various components of the robotic device 1200. Among possible power systems, the robotic device 1200 may include a hydraulic system, electrical system, batteries, and/or other types of power systems. As an example illustration, the robotic device 1200 may include one or more batteries configured to provide power to components via a wired and/or wireless connection. Within examples, components of the mechanical components 1214 and electrical components 1216 may each connect to a different power source or may be powered by the same power source. Components of the robotic device 1200 may connect to multiple power sources as well.

Within example configurations, any type of power source may be used to power the robotic device 1200, such as a gasoline and/or electric engine. Further, the power source(s) 1212 may charge using various types of charging, such as wired connections to an outside power source, wireless charging, combustion, or other examples. Other configurations may also be possible. Additionally, the robotic device 1200 may include a hydraulic system configured to provide power to the mechanical components 1214 using fluid power. Components of the robotic device 1200 may operate based on hydraulic fluid being transmitted throughout the hydraulic system to various hydraulic motors and hydraulic cylinders, for example. The hydraulic system of the robotic device 1200 may transfer a large amount of power through small tubes, flexible hoses, or other links between components of the robotic device 1200. Other power sources may be included within the robotic device 1200.

Mechanical components 1214 can represent hardware of the robotic device 1200 that may enable the robotic device 1200 to operate and perform physical functions. As a few examples, the robotic device 1200 may include actuator(s), extendable leg(s), arm(s), wheel(s), one or multiple structured bodies for housing the computing system or other components, and/or other mechanical components. The mechanical components 1214 may depend on the design of the robotic device 1200 and may also be based on the functions and/or tasks the robotic device 1200 may be configured to perform. As such, depending on the operation and functions of the robotic device 1200, different mechanical components 1214 may be available for the robotic device 1200 to utilize. In some examples, the robotic device 1200 may be configured to add and/or remove mechanical components 1214, which may involve assistance from a user and/or other robotic device.

The electrical components 1216 may include various components capable of processing, transferring, providing electrical charge or electric signals, for example. Among possible examples, the electrical components 1216 may include electrical wires, circuitry, and/or wireless communication transmitters and receivers to enable operations of the robotic device 1200. The electrical components 1216 may interwork with the mechanical components 1214 to enable the robotic device 1200 to perform various operations. The electrical components 1216 may be configured to provide power from the power source(s) 1212 to the various mechanical components 1214, for example. Further, the robotic device 1200 may include electric motors. Other examples of electrical components 1216 may exist as well.

In some implementations, the robotic device 1200 may also include communication link(s) 1218 configured to send and/or receive information. The communication link(s) 1218 may transmit data indicating the state of the various components of the robotic device 1200. For example, information read in by sensor(s) 1210 may be transmitted via the communication link(s) 1218 to a separate device. Other diagnostic information indicating the integrity or health of the power source(s) 1212, mechanical components 1214, electrical components 1216, processor(s) 1202, data storage 1204, and/or controller 1208 may be transmitted via the communication link(s) 1218 to an external communication device.

In some implementations, the robotic device 1200 may receive information at the communication link(s) 1218 that is processed by the processor(s) 1202. The received information may indicate data that is accessible by the processor(s) 1202 during execution of the program instructions 1206, for example. Further, the received information may change aspects of the controller 1208 that may affect the behavior of the mechanical components 1214 or the electrical components 1216. In some cases, the received information indicates a query requesting a particular piece of information (e.g., the operational state of one or more of the components of the robotic device 1200), and the processor(s) 1202 may subsequently transmit that particular piece of information back out the communication link(s) 1218.

In some cases, the communication link(s) 1218 include a wired connection. The robotic device 1200 may include one or more ports to interface the communication link(s) 1218 to an external device. The communication link(s) 1218 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

1. A method of grasping an object by a suction-based gripper of a mobile robot, the method comprising:
receiving, by a computing device, from a perception system of the mobile robot, perception information reflecting an object to be grasped by the suction-based gripper;
determining, by the computing device, uncertainty information reflecting an unknown or uncertain extent and/or pose of the object;
determining, by the computing device, a grasp strategy to grasp the object based, at least in part, on the uncertainty information; and
controlling, by the computing device, the mobile robot to grasp the object using the grasp strategy.

2. The method of claim 1, wherein
receiving perception information reflecting an object to be grasped comprises receiving information on a first extent and a second extent of a first face of the object, and
determining uncertainty information comprises determining uncertainty information for a third extent of a second face of the object.

3. The method of claim 2, wherein the second face shares one of the first extent or the second extent with the first face.

4. The method of claim 2, wherein determining a grasp strategy comprises:
assigning a classification to each of a plurality of suction cups of the suction-based gripper based, at least in part, on the uncertainty information and an orientation of the suction-based gripper relative to a face of the object having an uncertain extent,
wherein controlling the mobile robot to grasp the object comprises controlling the mobile robot to grasp the object based, at least in part, on the classification assigned to each of the plurality of suction cups of the suction-based gripper.

5. The method of claim 4, wherein determining uncertainty information for a third extent of a second face of the object comprises:
defining a first polygon relative to the second face, wherein the first polygon has a first value for the third extent; and
defining a second polygon relative to the second face, wherein the second polygon has a second value for the third extent, wherein the second value is larger than the first value.

6. The method of claim 5, wherein assigning a classification to each of a plurality of suction cups of the suction-based gripper comprises:
associating a first classification with a suction cup located within the first polygon; and
associating a second classification with a suction cup located outside of the first polygon and within the second polygon.

7. The method of claim 6, wherein controlling the mobile robot to grasp the object comprises selectively activating suction cups associated with the first classification.

8. The method of claim 6, wherein controlling the mobile robot to grasp the object comprises:
activating suction cups associated with the first classification at a first time; and
activating a first subset of suction cups associated with the second classification at a second time after the first time.

9. The method of claim 8, wherein controlling the mobile robot to grasp the object further comprises:
activating a second subset of suction cups associated with the second classification at a third time after the second time,
wherein the second subset includes at least one suction cup from the first subset and at least one suction cup not included in the first subset.

10. The method of claim 9, wherein the at least one suction cup not included in the first subset comprises a suction cup neighboring a suction cup in the first subset having a seal quality above a threshold seal quality.

11. The method of claim 8, wherein controlling the mobile robot to grasp the object further comprises:
deactivating one or more of the suction cups in the first subset having a seal quality below a threshold seal quality.

12. The method of claim 9, further comprising:
selecting suction cups to include in the first subset based, at least in part, on one or more of an amount of available vacuum pressure for the mobile robot, an amount of flow allowed through the suction-based gripper, or the orientation of the suction-based gripper relative to the face of the object.

13. The method of claim 1, wherein determining a grasp strategy comprises:
determining a pick trajectory of a manipulator including the suction-based gripper based, at least in part, on the uncertainty information; and
controlling the mobile robot to grasp the object comprises controlling the mobile robot to grasp the object based, at least in part, on the determined pick trajectory.

14. The method of claim 13, wherein determining a pick trajectory of the manipulator comprises:
determining a terminal end-effector pose of the pick trajectory based, at least in part, on the uncertainty information.

15. The method of claim 14, wherein determining a pick trajectory of the manipulator further comprises:
determining an intermediate end-effector pose of the pick trajectory; and
determining the pick trajectory by constraining the pick trajectory to follow a target twist with a constant angular component from the intermediate end-effector pose to the terminal end-effector pose.

16. The method of claim 15, wherein the intermediate end-effector pose is determined, at least in part, on one or more of the terminal end-effector pose, a reach of the manipulator or a height of a distance sensor on a base of the mobile robot.

17. The method of claim 15, wherein controlling the mobile robot to grasp the object based, at least in part, on the determined pick trajectory comprises:
detecting, as the manipulator is advanced along the pick trajectory, that a force associated with the manipulator exceeds a threshold value; and
stopping advancing of the manipulator in response to determining that the force exceeds the threshold value.

18. The method of claim 17, wherein controlling the mobile robot to grasp the object based, at least in part, on the determined pick trajectory further comprises:
activating one or more suction cups of the suction-based gripper as the manipulator is advanced along the pick trajectory; and
sensing as the force, a seal quality between one or more of the activated one or more suction cups and the object.

19. A mobile robot, comprising:
a suction-based gripper;
a perception system; and
at least one computing device programmed to:
receive from the perception system, perception information reflecting an object to be grasped by the suction-based gripper;
determine uncertainty information reflecting an unknown or uncertain extent and/or pose of the object;
determine a grasp strategy to grasp the object based, at least in part, on the uncertainty information; and
control the mobile robot to grasp the object using the grasp strategy.

20. A controller for a mobile robot, the controller comprising:
at least one computing device programed with a plurality of instructions that, when executed, perform a method comprising:
receiving from a perception system of the mobile robot, perception information reflecting an object to be grasped by the mobile robot;
determining uncertainty information reflecting an unknown or uncertain extent and/or pose of the object;
determining a grasp strategy to grasp the object based, at least in part, on the uncertainty information; and
controlling the mobile robot to grasp the object using the grasp strategy.
